(19) United States
(12) Patent Application Publication
(10) Pub. No.: US 2013/0013536 A1
(43) Pub. Date: Jan. 10, 2013

(54) METRIC LEARNING DEVICE, METRIC LEARNING METHOD, AND RECORDING MEDIUM

(75) Inventors: Michinari Momma, Minato-ku (JP); Satoshi Morinaga, Minato-ku (JP)

(73) Assignee: NEC CORPORATION, Tokyo (JP)

(21) Appl. No.: 13/519,076

(22) PCT Filed: Dec. 24, 2010
(86) PCT No.: PCT/JP2010/073457

§ 371 Date: Sep. 24, 2012

(30) Foreign Application Priority Data
Dec. 24, 2009 (JP) 2009-293415

(51) Int. Cl. G06F 15/18

(52) U.S. Cl. 706/12

(57) ABSTRACT

A metric learning device (110) is provided with: a storage unit (800) which stores data to be analyzed having a plurality of attributes, feedback information from a user, and metric information; a feedback converting unit (200) which converts the data to be analyzed into side information on the basis of the attribute of the data to be analyzed and/or the feedback information; a metric learning unit (300) which optimizes the metric information on the basis of the side information; a data analysis unit (400) which analyzes the data to be analyzed on the basis of the optimized metric information, and which outputs the analysis results thereof; and a client control unit (700) which displays the analysis results on a plurality of client devices, and which receives, from the plurality of client devices, feedback information which were received in response to the analysis results.

### TECHNICAL FIELD

The present invention relates to a metric learning device, metric learning method and recording medium that are suitable for a plurality of users to collaboratively use or work with.

### BACKGROUND ART

A metric learning device that learns data space metric on the basis of information from a user is known. A metric learning device first analyzes data with the use of metric that is not optimized in performing data analysis (for example, document clustering). When a user refers to the analyzed result and returns feedback to the metric learning device, the metric learning device converts the feedback to a form that is suitable for metric and performs metric learning. Patent Literature 1 discloses a data classification device that presents important information influencing a result of metric learning to a user thereby to improve efficiencies of feedback generation and metric learning.

### PRIOR ART LITERATURE

### Patent Literature

Patent Literature 1: Unexamined Japanese Patent Application Kokai Publication No. 2004-021590

### DISCLOSURE OF INVENTION

### Problems to be Solved by the Invention

In such a metric learning device, if a user can obtain knowledge other than the user, that is, knowledge of others, the user can return a more effective feedback. However, since in the data classification device disclosed in Patent Literature 1, it is not supposed that a plurality of users collaboratively perform one analysis, a user cannot obtain information on feedback from others and accordingly cannot devise an effective feedback based on knowledge of others. Then, a new approach that is suitable for a plurality of users to collaboratively use or work with is desired.

The present invention was made with the view of the above circumstances and an objective of the present invention is to provide a metric learning device, metric learning method and recording medium that are suitable for a plurality of users to collaboratively use or work with.

### Means for Solving the Problems

In order to achieve the above objective, a metric learning device according to a first aspect of the present invention includes:

a data acquisition unit configured to acquire data to be analyzed having a plurality of attributes, feedback information from a user that indicates a degree of relation between the data to be analyzed and metric information from which a degree of relation between the data to be analyzed is found;

a storage unit configured to store the data to be analyzed, the feedback information and the metric information that were acquired by the data acquisition unit;

a feedback converting unit configured to convert the data to be analyzed to side information indicating a degree of relation between the data to be analyzed, on the basis of an attribute of the data to be analyzed stored in the storage unit and/or the feedback information stored in the storage unit;

a metric learning unit configured to optimize the metric information stored in the storage unit on the basis of the side information converted by the feedback converting unit;

a data analysis unit configured to analyze the data to be analyzed stored in the storage unit on the basis of the metric information optimized by the metric learning unit and to output an analysis result of the analyzing; and

a client control unit configured to display the analysis result of the analyzing by the data analysis unit on a plurality of client devices that receive feedback information from a user and to receive the feedback information on the analysis result from the plurality of client devices.

A metric learning method according to a second aspect of the present invention includes:

a data acquisition step to acquire data to be analyzed having a plurality of attributes, feedback information from a user that indicates a degree of relation between the data to be analyzed, and metric information from which a degree of relation between the data to be analyzed is found;

a storage step to store the data to be analyzed, the feedback information and the metric information that were acquired at the data acquisition step;

a feedback converting step to convert the data to be analyzed to side information that indicates a degree of relation between the data to be analyzed, on the basis of an attribute of the data to be analyzed stored at the storage step and/or the feedback information stored at the storage step;

a metric learning step to optimize the metric information stored at the storage step on the basis of the side information converted at the feedback converting step;

a data analysis step to analyze the data to be analyzed stored at the storage step on the basis of the metric information optimized at the metric learning step and to output an analysis result of the analyzing; and

a client control step to display the analysis result analyzed at the data analysis step on a plurality of client devices that receive feedback information from a user and to receive feedback information on the analysis result from the plurality of client devices.

A computer-readable recording medium according to a third aspect of the present invention has a program to have a computer perform:

a data acquisition step to acquire data to be analyzed having a plurality of attributes, feedback information from a user that indicates a degree of relation between the data to be analyzed, and metric information from which a degree of relation between the data to be analyzed is found;

a storage step to store the data to be analyzed, the feedback information and the metric information that were acquired at the data acquisition step;

a feedback converting step to convert the data to be analyzed to side information that indicates a degree of relation between the data to be analyzed on the basis of an attribute of the data to be analyzed stored in the storage step and/or the feedback information stored at the storage step;

a metric learning step to optimize the metric information stored at the storage step on the basis of the side information converted at the feedback converting step;

a data analysis step to analyze the data to be analyzed stored at the storage step on the basis of the metric information optimized at the metric learning step and to output an analysis result of the analyzing; and

a client control step to display the analysis result analyzed at the data analysis step on a plurality of client devices that receive feedback information from a user and to receive feedback information on the analysis result from the plurality of client devices.

### Effects of the Invention

According to the present invention, a plurality of users can collaboratively use or work.

### BRIEF DESCRIPTION OF DRAWINGS

FIG. 1 is a schematic configuration of a typical information processor in which a metric learning device according to an embodiment of the present invention can be realized;

FIG. 2 is a schematic configuration of a metric learning device;

FIG. 3 is a schematic configuration of a metric learning unit;

FIG. 4 is a schematic configuration of a storage unit;

FIG. 5 is a schematic configuration of a metric storage unit;

FIG. 6 is a flow chart for describing a metric learning processing according to a first embodiment;

FIG. 7 is a schematic configuration of a metric learning device according to a second embodiment;

FIG. 8 is a schematic configuration of a storage unit according to the second embodiment; and

FIG. 9 is a flow chart for describing a metric learning processing according to the second embodiment.

### MODE FOR CARRYING OUT THE INVENTION

Hereinafter, a metric learning device according to embodiments of the present invention will be described with reference to drawings. The present invention can be applied to an information processor such as various computers, a personal data assistance (PDA) and a mobile phone. That is, embodiments described hereinafter are only for description, not limiting the scope of the present invention. Accordingly, a person skilled in the art can employ embodiments in which each element or all elements of these is/are replaced by equivalent(s), which are also included in the scope of the present invention.

### First Embodiment

A configuration of a typical information processor 100 in which a metric learning device according to an embodiment of the present invention is realized will be described with reference to drawings.

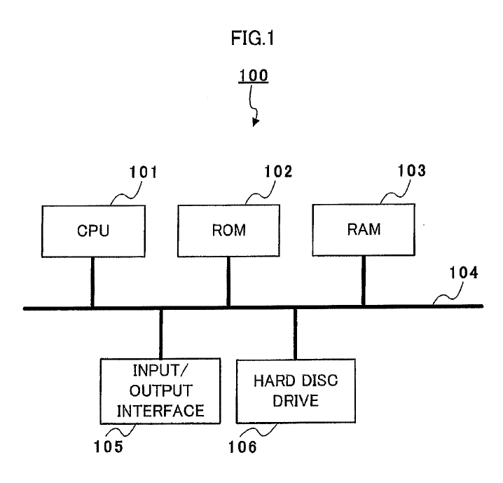

As illustrated in FIG. 1, the information processor 100 includes a central processing unit (CPU) 101, read only memory (ROM) 102, random access memory (RAM) 103, bus 104, input/output interface 105 and hard disc drive 106.

The CPU 101 is composed of, for example, a microprocessor unit, controls the whole operation of the information processor 100, and is connected to each component such as the ROM 102, the RAM 103, the input/output interface 105 and the hard disc drive 106 thereby to send and receive control signals and data therebetween. The CPU 101 performs various processing, which will be described later, according to a program stored in the ROM 102 and a program read out from the hard disc drive 106 to the RAM 103.

The ROM 102 is a read-only recording medium, and stores an initial program loader (IPL) that is executed immediately after power activation, an operating system program necessary for controlling operation of the whole of the information processor 100, various data and the like. The CPU 101 reads out the above program, various data and the like that are stored in the ROM 102 to the RAM 103, and executes them.

The RAM 103 is a storage medium that temporarily stores data and a program, and stores a program and data read out from the ROM 102 and hard disc drive 106, as well as other data necessary for progression of information processing.

The bus 104 connects each component such as the CPU 101, the ROM 102, the RAM 103, the input/output interface 105 and the hard disc drive 106 to each other.

The input/output interface 105 receives data inputted from outside of the information processor 100 and sends data to outside of the information processor 100. The input/output interface 105 is connected to an arbitrary device such as a keyboard, a mouse, a controller, a monitor such as a liquid crystal display, a speaker, a microphone and a network adaptor.

The hard disc drive 106 is a disc device that can store a large volume of data. The hard disc drive 106 may be an arbitrary writable/readable device such as a digital versatile disc (DVD) drive and the like.

Instead of the information processor 100, a common computer (for example, a general-purpose personal computer) can be used as a metric learning device according to the present invention. Hereinafter, unless otherwise noted, a metric learning device will be described with reference to the information processor 100 illustrated in FIG. 1. The metric learning device can be properly replaced by an element of a common computer according to need, and these embodiments are included in the scope of the present invention.

(Configuration of Metric Learning Device)

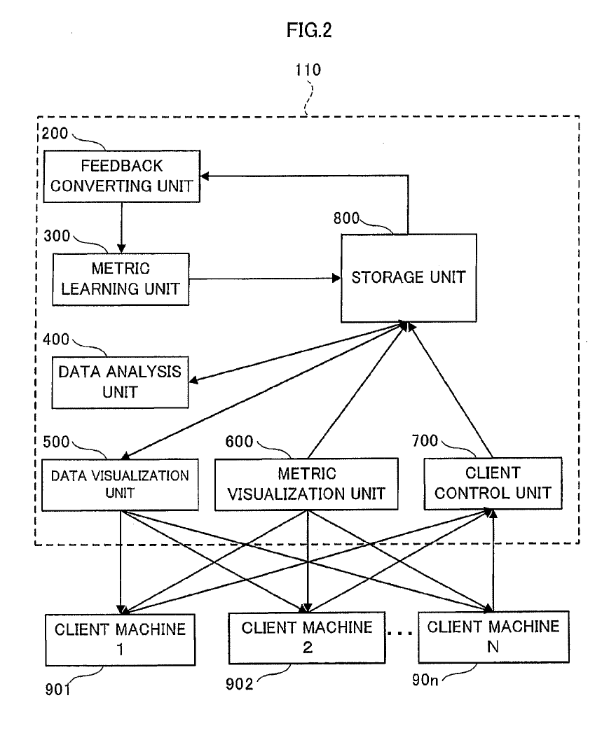

Next, a configuration of a metric learning device 110 according to the present embodiment will be described with reference to drawings. The metric learning device 110 is connected to a plurality of client machines 901 to 90n via a communication network or the like, as illustrated in FIG. 2. The metric learning device 110 is supposed to perform clustering of documents and/or the like, on the basis of input information inputted by a plurality of users via the plurality of client machines 901 to 90n.

The metric learning device 110 includes a feedback converting unit 200, metric learning unit 300, data analysis unit 400, data visualization unit 500, metric visualization unit 600, client control unit 700 and storage unit 800. Hereinafter, each component of the metric learning device 110 will be described.

Although functions of respective units that will be described later are related to each other, each of the units may be employed or may not be employed according to application. With respect to the metric learning device 110, a plurality of metric learning devices 110 may be provided for distributed processing as long as they achieve functions of the respective units that will be described later.

The feedback converting unit 200 converts feedback information that is inputted by a user or stored in the storage unit 800 to information indicating a mathematical representation (for example, constraint conditions of an optimum problem, side information). Then, the feedback converting unit 200 outputs the converted information indicating a mathematical representation to the metric learning unit 300. In the present embodiment, the feedback converting unit 200 converts feedback information to side information that will be described later. The above information indicating a mathematical representation can uniquely specify an operation of the metric learning device 110.

A type of the feedback information is arbitrary, for example, importance or unnecessity of clusters, division or binding of clusters, connection or disconnection of a link between clusters, an element of a metric matrix, and an element of a structured metric matrix.

The most basic side information that is used in a common metric learning technology is information indicating a degree of large or small distance between a pair of data. Although side information takes various forms, the metric learning device 110 utilizes, as side information, a relation between a common data pair, as well as information on a distance between a set (group) of data to be analyzed and data to be analyzed, and a degree of relation (similarity) between data sets (groups). The distance between data indicates a degree of unrelatedness (unsimilarity) between data; for example, a smaller value indicates that data are more related (more similar) to each other. A degree of relation (similarity) between data indicates a degree of relation of data (a degree of how data are similar to each other); for example, a larger value indicates that data are more related (similar) to each other.

The feedback converting unit 200 functions by cooperative operation of the CPU 101, ROM 102 and the like.

The metric learning unit 300 performs optimization processing of metric (for example, a predetermined relational expression for metric of data to be analyzed) on the basis of input data inputted from the feedback converting unit 200. Typically, the metric learning unit 300 optimizes a metric matrix for a new input, on the basis of metric learning input data that is generated from feedback information inputted by a plurality of users, a metric matrix that was previously optimized and corresponds to each user and a global metric matrix corresponding to all users. Then, the metric learning unit 300 has the storage unit 800 store the optimized metric information.

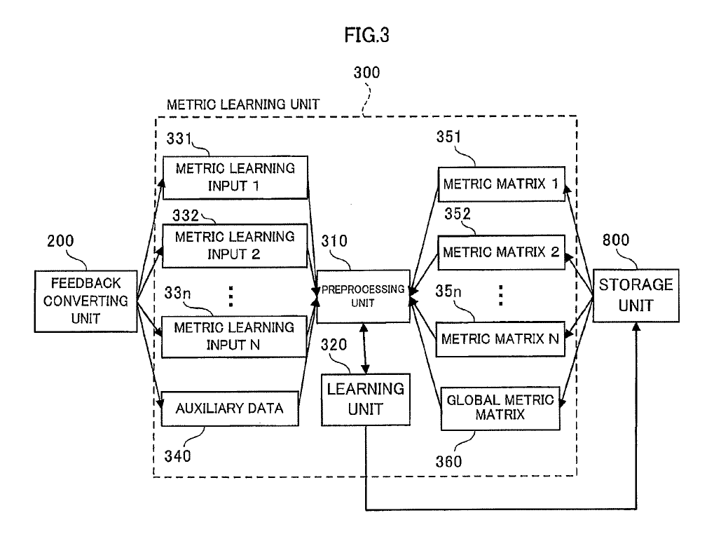

As illustrated in FIG. 3, the metric learning unit 300 is composed of a preprocessing unit 310 and learning unit 320. The preprocessing unit 310 performs preprocessing that will be described later when a plurality of metric learning inputs 331 to 33n and auxiliary data 340, as well as metric matrixes 351 to 35n and global metric matrix 360 that were previously stored or initially set, are inputted.

The auxiliary data 340 is auxiliary information on data to be analyzed. The auxiliary data 340 is arbitrary data, for example, data of analysis data itself or data obtained by condensing the analysis data by a method such as a well-known principal component analysis.

The metric matrixes 351 to 35n are conversion matrixes that define a degree of importance of an attribute of data to be analyzed corresponding to each user, or a relation between attributes.

The global metric matrix 360 is a conversion matrix that defines a degree of importance of an attribute of data to be analyzed corresponding to all users or a relation between attributes.

The preprocessing unit 310 generates information to be inputted to the learning unit 320 from each data. Hereinafter, a typical preprocessing method in the preprocessing unit 310 will be described, but the method is not limited to this.

### CONCRETE EXAMPLE 1

Metric learning for each user is performed thereby to optimize metric for each user. Global metric is independently optimized.

### CONCRETE EXAMPLE 2

Metric learning for each user is performed thereby to optimize metric for each user. Assuming that global metric is a convex sum of respective metrics, the global metric is optimized again.

### CONCRETE EXAMPLE 3

When metric learning for each user is performed, global metric is simultaneously optimized.

### CONCRETE EXAMPLE 4

In the preprocessing unit 310, metric learning inputs are integrated and global metric is learned. In this case, each metric is not calculated.

The learning unit 320 performs metric learning processing on the basis of input information preprocessed in the preprocessing unit 310. Hereinafter, concrete examples to optimize a problem that is metric learning processing performed in the learning unit 320 will be described for each of the above concrete examples of preprocessing in the preprocessing unit 310.

### CONCRETE EXAMPLE 1

min D(A^{u}, A_{D}^{u})+rLoss(constraint violation) s.t. constraints(u)+constraint violation A^{u} [symbol] 0 [Expression 1]

where D (A, B) represents a distance between metric matrixes A and B; and constraints(u) represents constraint conditions generated by feedback from a user (u). The learning unit 320 optimizes this independently for all users (u).

The learning unit 320 performs optimization independently for uεU, where U is a set of all users. Global metric optimizes all constraint conditions.

### CONCRETE EXAMPLE 2

In concrete example 2, after the learning unit 320 optimizes Expression 1 as with concrete example 1, Expression 2 is solved as global metric being Expression 3.

min D(A^{g}, A₀^{g})+rLoss(constraint violation) s.t.constraints(u) with constraint violation, ∀nεU A^{g} [symbol] 0 [Expression 2]

$${A}^{g} = {\sum }_{u ∈ U} {w}^{u} {A}^{u} \\ {\sum }_{u ∈ U} {w}^{u} = 1 \qquad [ Expression 3 ]$$

Here, since the learning unit 320 only has to solve expression 3 about w, the problem becomes much easier. Accordingly, the learning unit 320 can solve the problem at a higher speed than that of concrete example 1.

### CONCRETE EXAMPLE 3

In concrete example 3, the learning unit 320 optimizes all metrics and the global metric represented by expression 3 at the same time.

$$min {\sum }_{u ∈ U} D ( {A}^{u} , {A}_{0}^{u} ) + D ( {A}^{g} , {A}_{0}^{g} ) + r Loss ( constraint violation ) \\ s . t . constraints ( n ) with contraint violation \\ constraints ( g ) with contraint violation \\ {A}^{9} ≽ 0 , {A}^{u} ≽ 0 , u ∈ U \qquad [ Expression 4 ]$$

where constraints(g) represent constraints that place constraints of all users on global metric. In this case, since constraints on global metric have a more difficult form, it is difficult to solve the problem at a high speed.

### CONCRETE EXAMPLE 4

In concrete example 4, only global metric is considered.

min D(A^{g}, A₀^{g})+rLoss(constraint violation) s.t.constraints(u) with constraint violation. ∀uεU A^{g} [symbol] 0 [Expression 5]

In this case, since metric for each user is not calculated, it is difficult to perform a collaborative work using a difference between metric matrixes.

The metric learning unit 300 has the storage unit 800 store a result of metric learning, which updates each metric.

The metric learning unit 300 functions by cooperative operation of the CPU 101, ROM 102 and so on.

Returning to FIG. 2, the data analysis unit 400 performs a predetermined data analysis (for example, re-clustering) on the basis of optimized metric stored in the storage unit 800. Any method to analyze data can be employed. The data analysis unit 400 can analyze any problem as long as the problem analyzes data on the basis of a distance between respective data, such as, a classification problem, regression problem, clustering, and ranking problem.

The data analysis unit 400 also has the storage unit 800 store information on an analysis result, and provides the stored analysis result and information (1) to (5) that will be described later, to a user according to need. Each user considers feedback input on the basis of the analysis result and following information.

(1) Clustering Result to which Metric of a User is Applied

(2) Clustering Result to which each Metric Group is Applied

(3) Metric of a User

(4) Metric of each Metric Group

(5) Difference between Metric of the User Himself/Herself and Other Groups

The data analysis unit 400 functions by cooperative operation of the CPU 101, ROM 102 and so on.

The data visualization unit 500 visualizes data on the basis of an analysis result stored in the storage unit 800 and displays the visualized data on a monitor. The data visualization unit 500 also can send the visualized data to respective client machines 901 to 90n. In this case, a user can check the content of the visualized data and clusters on any of the client machines 901 to 90n. Then, the user returns feedback information though the client machines 901 to 90n. Any method to visualize data can be employed.

The data visualization unit 500 functions by cooperative operation of the CPU 101, input/output interface 105 and so on.

The metric visualization unit 600 visualizes a metric parameter (for example, a matrix parameter) and displays the visualized data on a monitor. The metric visualization unit 600 also can send the visualized data to the respective client machines 901 to 90n. Any method to visualize data metric can be employed.

The metric visualization unit 600 functions by cooperative operation of the CPU 101, input/output interface 105 and so on.

The client control unit 700 receives feedback information, data to be analyzed and so on from the client machines 901 to 90n and has the storage unit 800 store each of the received data and so on. For example, when the client control unit 700 receives the feedback information, the client control unit 700 has the storage unit 800 store the received feedback information; and when the client control unit 700 receives data to be analyzed, the client control unit 700 has the storage unit 800 store the received data to be analyzed.

The client control unit 700 functions by cooperative operation of the CPU 101, input/output interface 105 and so on.

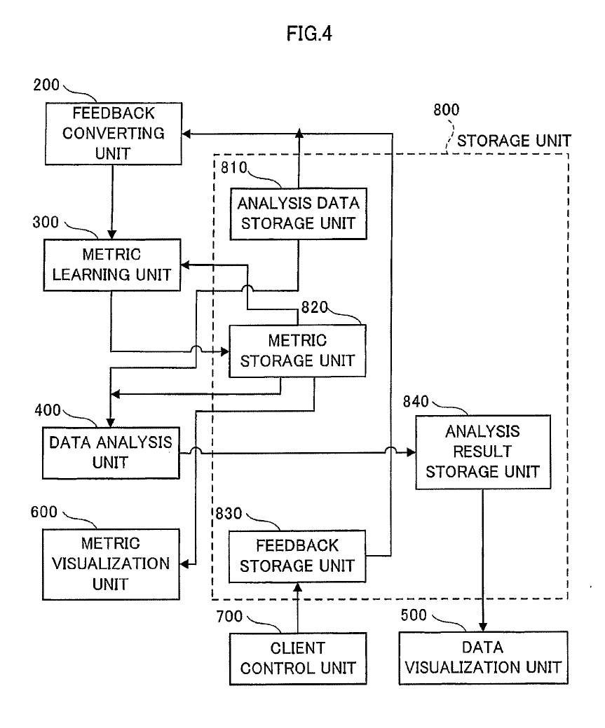

The storage unit 800 stores various data. Typically, the storage unit 800 stores feedback information inputted by each user, data to be analyzed, a data analysis result, history information of a metric learning result and so on. As illustrated in FIG. 4, the storage unit 800 is composed of an analysis data storage unit 810, metric storage unit 820, feedback storage unit 830 and analysis result storage unit 840.

The analysis data storage unit 810 stores data to be analyzed outputted from the client control unit 700. The data to be analyzed is provided to the feedback converting unit 200, data analysis unit 400 and the like.

The metric storage unit 820 stores metric data that is a metric learning result outputted from the metric learning unit 300. The metric data is provided to the metric learning unit 300, data analysis unit 400, metric visualization unit 600 and the like.

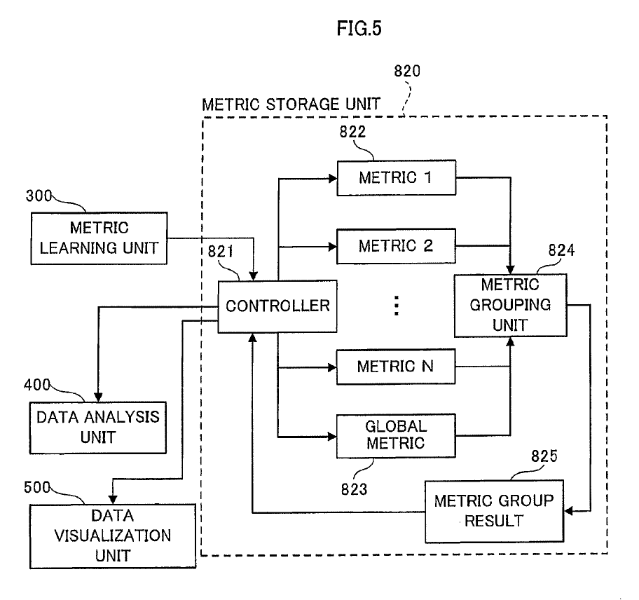

As illustrated in FIG. 5, the metric storage unit 820 is composed of a controller 821, metric 822, global metric 823, metric grouping unit 824 and metric group result 825.

The controller 821 has the storage device store metric data based on a metric learning result inputted from the metric learning unit 300 as the metric 822 and global metric 823. The controller 821 also outputs the metric data to the data analysis unit 400 and metric visualization unit 600. The controller 821 also receives the metric group result 825 grouped by the metric grouping unit 824.

The metric 822 is information that defines a degree of importance of an attribute of data to be analyzed corresponding to each user, or a relation between respective attributes. The global metric 823 is information that defines a degree of importance of an attribute of data to be analyzed corresponding to all users, or a relation between respective attributes. The metric group result 825 is a metric result grouped by the metric grouping unit 824.

The metric grouping unit 824 performs metric grouping. As a method of grouping, a well-known clustering method can be used. For example, the metric grouping unit 824 defines a distance between metrics as Frobenious norm between matrixes, which is used to perform clustering. The metric grouping unit 824 may use a well-known Graphical Lasso technology to learn an attribute network from a matrix element, represent the attribute network in the form of a graph, and use a clustering technology between a plurality of graphs.

Returning to FIG. 4, the feedback storage unit 830 stores feedback information outputted from the client control unit 700. The feedback information is provided to the feedback converting unit 200 and the like.

The analysis result storage unit 840 stores an analysis result outputted from the data analysis unit 400. The analysis result is provided to the data visualization unit 500.

The storage unit 800 functions by cooperative operation of the CPU 101, RAM 103, hard disc drive 106 and so on.

Returning to FIG. 2, the client machines 901 to 90n, each includes any device such as an input receiving device that receives an input from a user, a display device that displays information outputted from the metric learning device 110 and a storage device that stores predetermined information and the like.

The client machines 901 to 90n displays various visualization data generated by the metric learning device 110, an analysis result and a history thereof and the like. A user operates the client machines 901 to 90n to input feedback information on the analysis result and metric matrix. The client machines 901 to 90n send various data inputted by a user to the metric learning device 110. The client machines 901 to 90n typically are realized by a personal computer, mobile terminal or the like, but is not limited to these and any machine can be employed as long as the machine achieves the above functions.

The metric learning device 110 is connected to the client machines 901 to 90n via a wired or wireless communication network. Therefore, between the metric learning device 110 and the client machines 901 to 90n, as well as among the client machines 901 to 90n, data is arbitrarily sent and received.

Next, operation of metric learning processing will be described with reference to drawings.

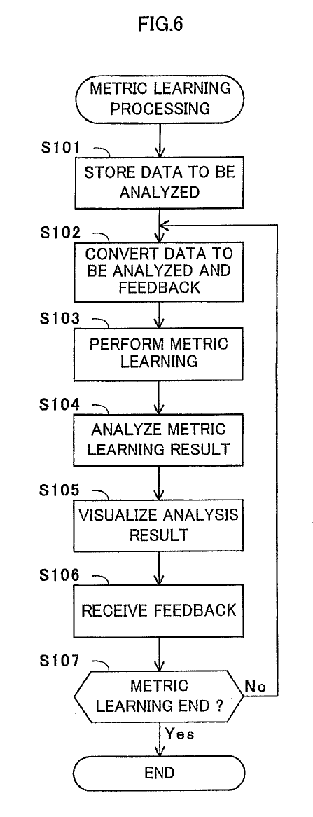

First, once the metric learning device 110 receives data to be analyzed from the client machines 901 to 90n, the metric learning device 110 starts metric learning processing illustrated in FIG. 6. The metric learning device 110 receives data to be analyzed from the client machines 901 to 90n, and stores the received data to be analyzed in the storage unit 800 (analysis data storage unit 810) (Step S101). A source of data is arbitrary, and here is a document obtained by crawling on a website. As metric, Mahalanobis metric is used. Any method to receive data to be analyzed can be employed; for example, data is received from the client machines 901 to 90n via a network.

Next, the feedback converting unit 200 performs conversion processing of data to be analyzed stored in the analysis data storage unit 810 and feedback information from users stored in the feedback storage unit 830 (Step S102). For example, if an attribute of a document is a word, the original document data is converted to numerical data having a word attribute by a well-known morphological analysis technology.

In the first processing, since there is no feedback information from a user, the feedback converting unit 200 performs conversion processing of data to be analyzed stored in the analysis data storage unit 810. In the second and later processing, if there is feedback information from a user, the feedback converting unit 200 performs conversion processing of feedback information stored in the feedback storage unit 830.

Next, the metric learning unit 300 performs metric learning (metric optimization processing) from conversion data inputted from the feedback converting unit 200 (Step S103). Typically, the metric learning unit 300 optimizes a metric matrix for a new input, on the basis of metric learning input data generated from feedback information inputted by a plurality of users, a metric matrix that was previously optimized and corresponds to each user and a global metric matrix corresponding to all users. Then, the metric learning unit 300 has the storage unit 800 (metric storage unit 820) store the optimized metric information. As a result of metric learning, necessary information according to a request from a user is outputted, such as an individual metric, a global metric and a grouped metric and the like.

Next, the data analysis unit 400 uses initial metric data stored in the metric storage unit 820 or metric data generated from feedback information inputted by a user to perform analysis of a metric learning result (clustering analysis) (Step S104). Then, the data analysis unit 400 has the storage unit 800 (analysis result storage unit 840) store a result of clustering analysis. As a clustering analysis method, a well-known method can be used.

Next, the data visualization unit 500 visualizes an analysis result (for example, content of a cluster) stored in the analysis result storage unit 840 by an arbitrary visualization processing (Step S105). Then, the data visualization unit 500 transfers the visualized analysis result to the client machines 901 to 90n. This processing enables a plurality of users to concurrently browse the analysis result through the client machines 901 to 90n of the respective users. Each user can obtain a new knowledge from a difference between the individual metric matrix and the global metric matrix. Then, each user examines the visualized analysis result, and sends feedback information on the analysis result via each of the client machines 901 to 90n to the metric learning device 110.

Information of a metric learning result and metric matrix can be presented to users in such a way that the information is subjected to perform metric grouping by the metric grouping unit 824 of the metric storage unit 820 for improvement of readability and efficiency, thereby condensing the information. This enables a user to browse information such as a difference between a metric matrix including the user and a metric matrix corresponding to the user, information of users that belong to a group, and an average metric matrix of other groups.

Next, the client control unit 700 receives feedback information from a plurality of users via the plurality of client machines 901 to 90n (Step S106). Then, the client control unit 700 has the storage unit 800 (feedback storage unit 830) store the received feedback information. A type of the feedback information is, for example, importance or unnecessity of clusters, division or binding of clusters, connection or disconnection of a link between clusters, an element of a metric matrix, and an element of a structured metric matrix and the like.

Next, the metric learning unit 300 determines if metric learning has ended or not (Step S107). If metric learning has ended (Step S107; Yes), the metric learning device 110 terminates metric learning processing. If metric learning has not ended (Step S107; No), the metric learning device 110 repeats the above Steps S102 to S107.

The above processing enables a plurality of users to perform analysis work using metric learning. Since a plurality of users can collaboratively perform analysis work, a user can share knowledge inputted by other users as feedback and obtain a new knowledge. In addition, since analysis work can be divided by a plurality of users, an efficiency of the analysis can be improved.

### Second Embodiment

In a second embodiment, a metric learning device to which an active learning function is added will be described. The same configuration and operation as those of the metric learning device 110 according to the first embodiment have the same reference numbers and may not be described.

(Configuration of Metric Learning Device)

First, each component of a metric learning device 120 of the present embodiment will be described with reference to drawings.

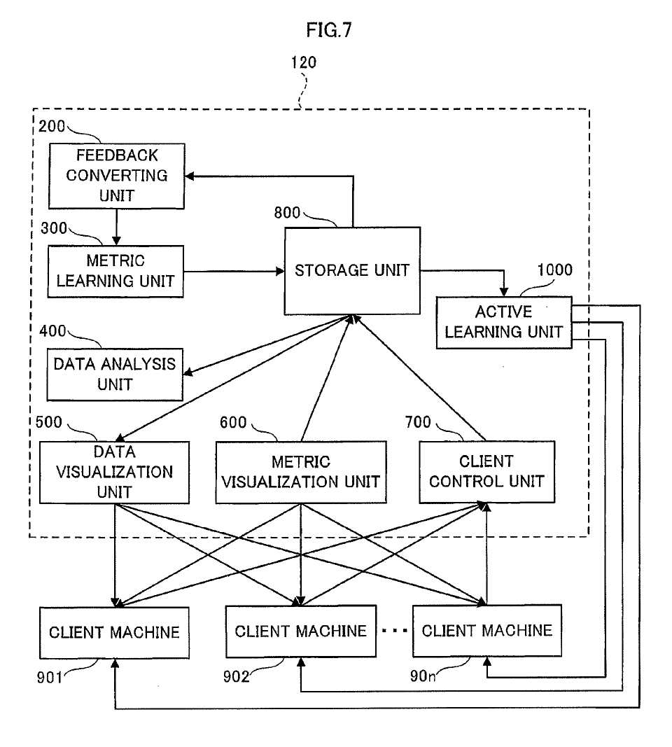

As illustrated in FIG. 7, the metric learning device 120 includes a feedback converting unit 200, metric learning unit 300, data analysis unit 400, data visualization unit 500, metric visualization unit 600, client control unit 700, storage unit 800 and active learning unit 1000. Since the feedback converting unit 200, metric learning unit 300, data analysis unit 400, data visualization unit 500, metric visualization unit 600, client control unit 700 and storage unit 800 are the same as those of the metric learning device 110 according to the first embodiment, they will not be described. Hereinafter, the active learning unit 1000 will be mainly described.

The active learning unit 1000 performs active learning on data.

Here, active learning urges a user to select important data, and performs metric learning with the use of results of queries inputted by the user for issuing various instructions. Generally, an active operation of active learning is performed with the use of fewest possible labels by acquiring a query on data label information from a user. Active learning is typically applied to data that has a high operation cost for labeling, such as classification of texts and classification of molecules to be used for chemicals.

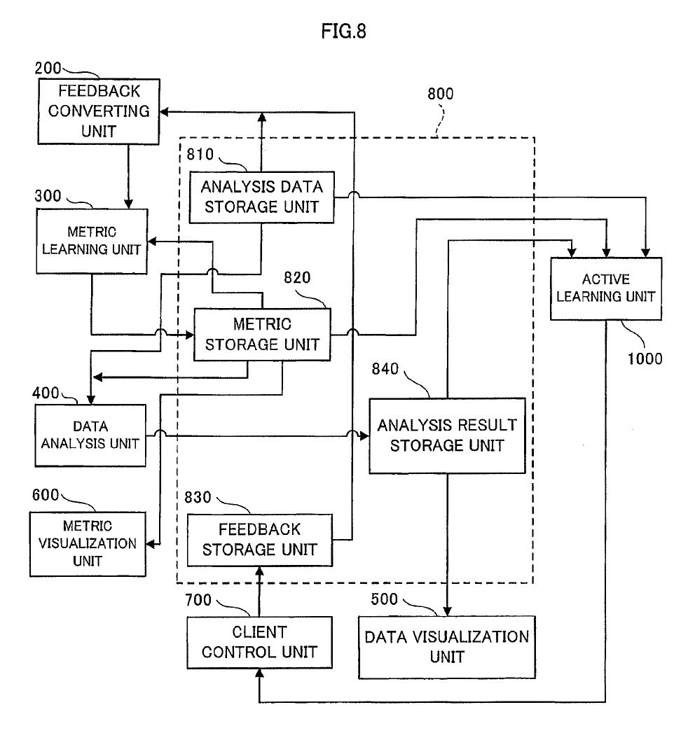

As illustrated in FIG. 8, the active learning unit 1000 performs active learning on the basis of data to be analyzed stored in the analysis data storage unit 810, metric data stored in the metric storage unit 820 and an analysis result stored in the analysis result storage unit 840, and sends a result of the active learning to the client machines 901 to 90n.

Next, operation of metric learning processing according to the second embodiment will be described with reference to drawings. The same reference numbers are assigned to the same steps as those of the flow chart of the first embodiment illustrated in FIG. 6 and will not be described.

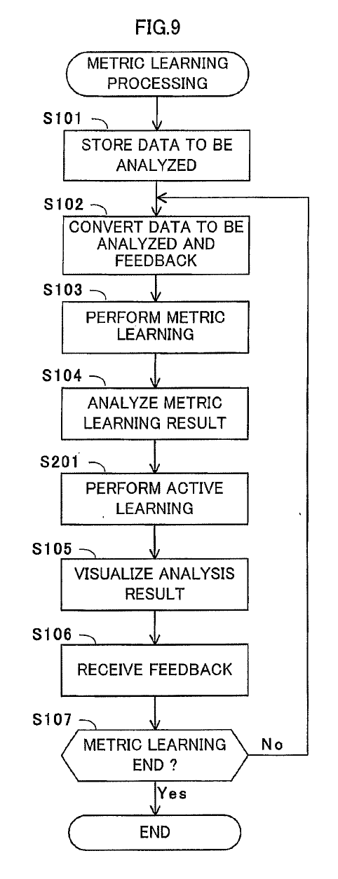

As illustrated in FIG. 9, after the data analysis unit 400 performs a metric learning result analysis (clustering analysis) at Step S104, the active learning unit 1000 performs active learning on the basis of the analysis result and the like (Step S201).

Here, active learning will be described in detail. The active learning unit 1000 performs active learning on the basis of, for example, the following result information.

(1) Metric Learning Result Stored in the Metric Storage Unit 820

(2) Analysis Result Stored in the Analysis Result Storage Unit 840

If active learning is performed with the use of (1) Metric learning result, the active learning unit 1000 finds, for a user group formed in the metric grouping unit 824, a difference in metric matrixes within the group. Further, the active learning unit 1000 generate a message to confirm a user, regarding attributes whose importance are most different to each other and similarities between attributes that are most different to each other.

If active learning is performed with the use of (2) Analysis result, the active learning unit 1000 performs user grouping, and generates a message, for each of the user groups, to confirm different cluster results.

The active learning unit 1000 also extracts a group of users whose analysis results stored in the analysis result storage unit 840 are particularly similar to each other, and applies a well-known active learning to a common clustering. Active learning processing includes processing to extract important data (such as data that causes a significant change in progression of data analysis) from data to be analyzed and processing to rank the extracted important data. Any method to extract important data can be employed; for example, attributes that are correlated to each other may be found on the basis of “a correlation exponent” that is a statistical index indicating correlation (a degree of similarity) between two variables.

The active learning unit 1000 has the metric learning device 120 actively assign a work to a group of users that collaboratively work, and returns a message. Content of the message is generated in the active learning unit 1000. Then, the active learning unit 1000 sends a result of active learning to the client machines 901 to 90n and presents the result of active learning as a message to users.

In order to make analysis work more efficient, it is important to grasp a characteristic of each user. Therefore, in the present embodiment, a score of each user is defined. Then, the active learning unit 1000 returns a suitable message in descending order of the highest score, thereby making the work more efficient on the whole.

Here, the score may be an evaluation by other users or a degree of progression of clustering. The degree of progression of clustering is determined on the basis of a learning curve, but is not limited to this, and an index such as finding a cluster with a higher consensus compared with a cluster result of other users may be employed.

At Step S201, after active learning, the data visualization unit 500 visualizes an analysis result including a result of active learning (Step S105). Then, the metric learning device 120 performs processing described in the first embodiment and terminates metric learning processing.

By the above processing, important information that have an effect on a learning result in metric learning is presented to users, enabling the users to generate feedback information and improve an efficiency of metric learning. Further, the metric learning device 120 can recommend to users the feedback information that maximizes an amount of information a metric matrix has.

The present invention is not limited to the above embodiments, and various modifications and applications are possible.

The metric learning unit 300 is not limited to metric optimization, and can optimize any information, for example, multimedia data such as an image and sound, a crawling and a search order and the like. As a method of optimization, a well-known method can be applied.

The above hardware configurations and flow charts are examples and can be arbitrarily changed and modified.

A main section to perform processing of the metric learning device 110 and metric learning device 120, which are composed of the feedback converting unit 200, metric learning unit 300, data analysis unit 400, data visualization unit 500, metric visualization unit 600, client control unit 700, storage unit 800 and active learning unit 1000, and the client machines 901 to 90n is not dedicated systems, but can be realized with the use of a common computer system. For example, a computer program for performing the above operations may be stored and distributed in a computer-readable recording medium (for example, a flexible disc, CD-ROM, DVD-ROM), and by installing the computer program into a computer, the metric learning device 110 or metric learning device 120 that performs the above processing may be configured. Alternatively, the computer program may be stored in a storage device of a server device on a communication network such as the Internet and the like, and by a common computer system's downloading the computer program, the metric learning device 110 or metric learning device 120 and the like may be configured.

In the case where functions of the metric learning device 110 or metric learning device 120 are realized by dividing the functions to an operating system (OS) and an application program, or by collaboratively operating the functions by the OS and the application program, only the application program may be stored in a recording medium or a storage device.

It is also possible that a computer program is superimposed on a carrier wave and distributed via a communication network. For example, the computer program may be posted on a bulletin board system (BBS) of a communication network and distributed via the network. Then, by activating the computer program and executing it with other application programs under control of the OS, the above processing may be performed.

In the present invention, various embodiments and modifications are possible without departing from a broad purpose and scope of the present invention. The above embodiments are only for an illustrative purpose of the present invention, and do not limit the scope of the present invention. That is, the scope of the present invention is defined by the scope of claims, not the embodiments. Various modifications within the scope of claims and the scope of their equivalent inventions are deemed to be within the scope of the present invention.

The present application is based on Japanese Patent Application No. 2009-293415 dated Dec. 24, 2009. The entire specification, claims and drawings of Japanese Patent Application No. 2009-293415 shall be incorporated in the present specification as reference.

### INDUSTRIAL APPLICABILITY

As described above, the present invention can provide a metric learning device, metric learning method and recording medium that are suitable for a plurality of users to collaboratively use or work with.

### DESCRIPTION OF REFERENCE NUMBERS

100 Information processor

101 CPU

102 ROM

103 RAM

104 Bus

105 Input/output interface

106 Hard disc drive

110, 120 Metric learning device

200 Feedback converting unit

300 Metric learning unit

310 Preprocessing unit

320 Learning unit

331 to 33n Metric learning input

340 Auxiliary data

351 to 35n Metric matrix

360 Global metric matrix

400 Data analysis unit

500 Data visualization unit

600 Metric visualization unit

700 Client control unit

800 Storage unit

810 Analysis data storage unit

820 Metric storage unit

821 Controller

822 Metric

823 Global metric

824 Metric grouping unit

825 Metric group result

830 Feedback storage unit

840 Analysis result storage unit

901 to 90n Client machines

1000 Active learning unit

1. A metric learning device comprising:
a data acquisition unit configured to acquire data to be analyzed having a plurality of attributes, feedback information from a user indicating a degree of relation between the data to be analyzed, and metric information from which a degree of relation between the data to be analyzed is found;
a storage unit configured to store the data to be analyzed, the feedback information and the metric information that were acquired by the data acquisition unit;
a feedback converting unit configured to convert the data to be analyzed to side information indicating a degree of relation between the data to be analyzed, on the basis of an attribute of the data to be analyzed stored in the storage unit and/or the feedback information stored in the storage unit;
a metric learning unit configured to optimize the metric information stored in the storage unit on the basis of the side information converted by the feedback converting unit;
a data analysis unit configured to analyze the data to be analyzed stored in the storage unit on the basis of the metric information optimized in the metric learning unit and to output an analysis result of the analyzing; and
a client control unit configured to display the analysis result analyzed by the data analysis unit on a plurality of client devices that receive the feedback information from a user and to receive the feedback information on the analysis result from the plurality of client devices.

2. The metric learning device according to claim 1 wherein
the data acquisition unit further acquires a global metric information from which a degree of relation between data to be analyzed is found and that corresponds to all users;
the storage unit further stores the global metric information acquired by the data acquisition unit;
the metric learning unit optimizes the global metric information stored in the storage unit; and
the data analysis unit analyzes the data to be analyzed stored in the storage unit on the basis of a difference between the global metric information optimized in the metric learning unit and the metric information optimized in the metric learning unit.

3. The metric learning device according to claim 2, further comprising a metric grouping unit that groups the metric information or the global metric information stored in the storage unit for each user.

4. The metric learning device according to claim 2, further comprising an active learning unit that performs active learning on the metric information stored in the storage unit or the metric information grouped by the metric grouping unit.

5. The metric learning device according to claim 2, wherein the metric learning unit optimizes a metric matrix for a new input, on the basis of metric learning input data generated from the feedback information stored in the storage unit to be used for metric learning, a metric matrix that was previously optimized and corresponds to each user and the global metric matrix stored in the storage unit.

6. The metric learning device according to claim 4, wherein the active learning unit extracts important data to be analyzed that causes a significant change in progression of data analysis from the data to be analyzed stored in the storage unit and ranks the extracted data to be analyzed.

7. The metric learning device according to claim 4, wherein the active learning unit associates users with scores and generates a message in descending order of the highest score.

8. The metric learning device according to claim 1, wherein the client control unit displays the analysis result based on the feedback information received from any of the client devices on client devices other than a client device from which the feedback information was received.

9. The metric learning device according to claim 3, wherein the metric grouping unit sets a distance of the metric information or the global metric information that are stored in the storage unit to be Frobenious norm between matrixes and performs clustering on the basis of the Frobenious norm.

10. The metric learning device according to claim 3, wherein the metric grouping unit learns an attribute network from a matrix element a distance of the metric information or the global metric information that are stored in the storage unit on the basis of Graphical Lasso thereby to find a graph of the attribute network.

11. The metric learning device according to claim 4, wherein the active learning unit finds a difference of a metric matrix within a group grouped by the metric grouping unit on the basis of metric information optimized in the metric learning unit, and generates a message about data whose difference is the largest.

12. The metric learning device according to claim 4, wherein the active learning unit groups users on the basis of the analysis result analyzed by the data analysis unit, and generates a message to the group.

13. The metric learning device according to claim 1, wherein the data analysis unit outputs, at least one of a result of application of metric of a user, a result of application of each metric group, metric of a user, metric of each metric group, and a difference between metric of a user himself/herself and metric of other groups, to the client control unit.

14. The metric learning device according to claim 2, wherein the metric information and the grouping information stored in the storage unit are Mahalanobis metric.

15. A metric learning method comprising:
a data acquisition step to acquire data to be analyzed having a plurality of attributes, feedback information from a user indicating a degree of relation between the data to be analyzed, and metric information from which a degree of relation between the data to be analyzed is found;
a storage step to store the data to be analyzed, the feedback information and the metric information that were acquired at the data acquisition step;
a feedback converting step to convert the data to be analyzed to side information indicating a degree of relation between the data to be analyzed, on the basis of an attribute of the data to be analyzed stored at the storage step and/or the feedback information stored at the storage step;
a metric learning step to optimize the metric information stored at the storage step on the basis of the side information converted at the feedback converting step;
a data analysis step to analyze the data to be analyzed stored at the storage step on the basis of the metric information optimized at the metric learning step and to output an analysis result of the analyzing; and
a client control step to display the analysis result analyzed at the data analysis step on a plurality of client devices that receive the feedback information from a user and to receive the feedback information on the analysis result from the plurality of client devices.

16. A computer-readable recording medium that records a program, the program having a computer perform:
a data acquisition step to acquire data to be analyzed having a plurality of attributes, feedback information from a user indicating a degree of relation between the data to be analyzed, and metric information from which a degree of relation between the data to be analyzed is found;
a storage step to store the data to be analyzed, the feedback information and the metric information that were acquired at the data acquisition step;
a feedback converting step to convert the data to be analyzed to side information indicating a degree of relation between the data to be analyzed, on the basis of an attribute of the data to be analyzed stored at the storage step and/or the feedback information stored at the storage step;
a metric learning step to optimize the metric information stored at the storage step on the basis of the side information converted at the feedback converting step;
a data analysis step to analyze the data to be analyzed stored at the storage step on the basis of the metric information optimized at the metric learning step and to output an analysis result of the analyzing; and
a client control step to display the analysis result analyzed at the data analysis step on a plurality of client devices that receive feedback information from a user and to receive feedback information on the analysis result from the plurality of client devices.
